(19) United States
(12) Patent Application Publication
(10) Pub. No.: US 2025/0351777 A1
(43) Pub. Date: Nov. 20, 2025

(54) RESIDUE PROFILING SYSTEM

(71) Applicant: Deere & Company, Moline, IL (US)

(72) Inventors: Rana Shakti Singh, RAMGARH (IN); Nathan R. Vandike, Geneseo, IL (US); Debanjan Banerjee, Pune (IN)

(21) Appl. No.: 18/668,420

(22) Filed: May 20, 2024

(51) Int. Cl. A01F 12/40; A01F 12/44

(52) U.S. Cl. CPC A01F 12/40; A01F 12/444; A01F 12/446

(57) ABSTRACT

A grain harvesting machine includes a grain thresher and a cleaning subsystem for separating grain from MOG. A residue subsystem includes a chopper including a chopper housing, a rotatable chopper rotor carrying a plurality of chopper knives, and a stationary knife assembly configured to interact with the chopper knives to chop the MOG into smaller pieces before the MOG is distributed onto the ground surface. The chopper includes a chopper inlet, a chopper outlet, a MOG flow area between the inlet and the outlet wherein MOG is expected to flow during normal operation, and a MOG non-flow area where MOG is not expected to flow during normal operation. A residue monitoring system includes at least one sensor configured to detect a presence of MOG in the MOG non-flow area.

### BACKGROUND

### 1. Field of the Disclosure

The present application relates to systems for monitoring and controlling the discharge of residue in the operation of a grain harvesting machine.

### 2. Background of the Disclosure

When operating a grain harvesting machine the material flow paths within the machine may sometimes become plugged, resulting in downtime and potentially in machine damage. One particular area subject to such plugging is the residue subsystem, particularly the chopper which is intended to chop the material other than grain (MOG) into small pieces before it is discharged and spread onto the field behind the grain harvesting machine.

### SUMMARY

The present disclosure provides systems for monitoring a build up of MOG in areas of the residue subsystem where MOG should not be present, and for taking corrective action to prevent the MOG build up from reaching levels where it interferes with the continuing operation of the harvesting machine.

In a first embodiment a grain harvesting machine for harvesting a crop material and separating the crop material into grain and material other than grain (MOG), includes a grain thresher configured to separate grain from MOG, and a cleaning subsystem for further separating MOG from the separated grain. A residue subsystem is provided for chopping the MOG and distributing the MOG onto a ground surface behind the grain harvesting machine. The residue subsystem includes a chopper including a chopper housing, a rotatable chopper rotor carrying a plurality of chopper knives, and a stationary knife assembly fixed in position relative to the chopper housing and configured to interact with the chopper knives to chop the MOG into pieces before the MOG is distributed onto the ground surface. The chopper includes a chopper inlet configured to receive the MOG, a chopper outlet configured to distribute the MOG, a MOG flow area between the inlet and the outlet wherein MOG is directed to flow during normal operation, and a MOG non-flow area where MOG is not directed to flow during normal operation. A residue monitoring system includes at least one sensor configured to detect a presence of MOG in the MOG non-flow area.

In another embodiment a method of operating such a grain harvesting machine includes: detecting with at least one sensor a presence of MOG in the MOG non-flow area above a threshold level; and initiating a responsive action with a controller if the presence of MOG in the MOG non-flow area above the threshold level is detected.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a schematic left side elevation view of a grain harvesting machine.

FIG. 2 is an enlarged schematic elevation sectioned view of the chopper and material spreader at the discharge of the grain harvesting machine.

FIG. 3 is a schematic plan view showing sensors mounted on the side walls of the chopper housing.

FIG. 4 is a schematic plan view showing sensors mounted on the back wall of the chopper housing.

FIG. 5 is a schematic illustration of a control system of the grain harvesting machine of FIG. 1.

FIG. 6 is a schematic illustration of an array of sensors mounted on one of the side walls of the chopper housing, and a knife blade passing in front of the sensors so that knife wear or other operational condition of the knife is detected.

### DETAILED DESCRIPTION

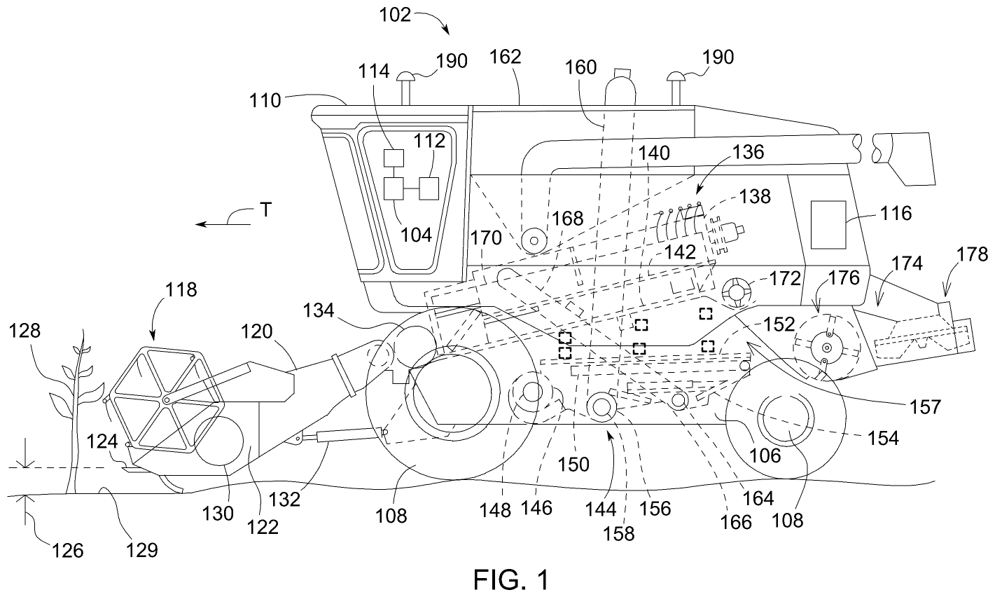

Referring now to FIG. 1, a grain harvesting machine 102 in the form of a combine harvester is shown. The grain harvesting machine 102 includes a controller 104 that controls and/or facilitates operation of various aspects of the grain harvesting machine 102.

As shown, the example grain harvesting machine 102 includes a chassis 106 with ground-engaging wheels 108 or tracks. The wheels 108 are rotatably mounted to the chassis 106 and engage with the ground to propel the grain harvesting machine 102 in a travel direction T. An operator's cab 110, also mounted to the chassis 106, houses an operator as well as various devices to control the harvester 102, such as one or more operator input devices 112 and/or display devices 114, further described below.

The wheels 108 and other devices of the harvester 102 are powered by an internal combustion engine 116 or other power source. The engine 116 may be operated based on commands from the operator and/or the controller 104.

A header 118 is mounted at the front of the chassis 106 of the grain harvesting machine 102 to cut and gather crop material 128 from a field. The header 118 is supported by a feederhouse 120 pivotally mounted to the chassis 106. The header 118 includes a frame 122 supporting a cutter bar 124 that extends substantially across the length of the header 118 and that functions to cut crops 128 along the ground 129. The header 118 may further include a mechanism for collecting the cut material from the cutter bar 124. In this example, the header 118 includes an auger 130 to transport the cut crop material towards the center of the header 118. Other examples may include one or more conveyors. The header 118 may include a header actuator 132 that functions to reposition the header 118 relative to the ground and/or in front and rearward directions. The header actuator 132 may adjust a header cutting elevation 126 at which the cutter bar 124 cuts the crops 128 above the ground surface 129. The feederhouse 120 may include, for example, an inclined conveyor (not shown) to transport cut crop material from the header 118 into the body of the grain harvesting machine 102.

After passing over a guide drum or feed accelerator 134, the crop material from the feederhouse 120 reaches a generally fore-aft oriented threshing device or separator or thresher 136. Other embodiments may include laterally oriented or other threshing devices (not shown). In the embodiment depicted, the separator 136 includes a rotor 138 on which various threshing elements are mounted. The rotor 138 rotates above one or more grated or sieved threshing baskets or concaves 140, such that crop material passing between the rotor 138 and the concaves 140 is separated, at least in part, into grain and chaff (or other “material other than grain” (MOG)). A threshing clearance between the rotor 138 and the concaves 140 may be adjusted with one or more concave actuators 142 (schematically shown). The concave actuators 142, as well as further actuators associated with the concaves 140, may be operated based on commands from the operator and/or the controller 104. The MOG is carried rearward and released from between the rotor 138 and the concaves 140. Most of the grain (and some of the MOG) separated in the separator 136 falls downward through apertures in the concaves 140.

Agricultural material passing through the concaves 140 falls (or is actively fed) into a cleaning subsystem (or cleaning shoe) 144 for further cleaning. The cleaning subsystem 144 includes a fan 146, driven by an actuator 148, that generates generally rearward air flow, as well as a sieve 150 and a chaffer 152. The sieve 150 and the chaffer 152 are suspended with respect to the chassis 106 by an actuation arrangement 154 that may include pivot arms and rocker arms mounted to disks (or other devices). The sieve 150, chaffer 152 and actuator arrangement 154 may be collectively referred to as a sieve and chaffer system. As the fan 146 blows air across and through the sieve 150 and the chaffer 152, the actuation arrangement 154 may cause reciprocating motion of the sieve 150 and the chaffer 152 (e.g., via movement of the rocker arms). The combination of this motion of the sieve 150 and the chaffer 152 with the air flow from the fan 146 generally causes the lighter chaff to be blown upward and rearward within the grain harvesting machine 102 and to flow out the rear end of the grain harvesting machine at rear outlet area or chaff outlet 157. The heavier grain falls through the sieve 150 and the chaffer 152 and accumulates in a clean grain trough 156 near the base of the grain harvesting machine 102. Depending on the operational settings of various operating parameters of the grain harvesting machine 102, some amount of grain may be unintentionally “overblown” with the lighter chaff material out the rear outlet area 157.

A clean grain auger 158 disposed in the clean grain trough 156 carries the material to the one side of the grain harvesting machine 102 and deposits the grain in the lower end of a clean grain elevator 160. The clean grain lifted by the clean grain elevator 160 is carried upward until it reaches the upper exit of the clean grain elevator 160. The clean grain is then released from the clean grain elevator 160 and falls or is deposited into a grain tank 162.

Most of the grain entering the cleaning subsystem 144, however, is not carried rearward, but passes downward through the chaffer 152, then through the sieve 150. Of the material carried by air from the fan 146 to the rear of the sieve 150 and the chaffer 152, smaller MOG particles are blown out of the rear of the grain harvesting machine 102. Larger MOG particles and grain are not blown off the rear of the grain harvesting machine 102, but rather fall off the cleaning subsystem 144.

Heavier material carried to the rear of the chaffer 152 exits out of the grain harvesting machine 102. Heavier material carried to the rear of the sieve 150 falls onto a pan and is then conveyed by gravity downward into a grain tailings trough 164 in the form of “tailings,” typically a mixture of grain and MOG. A tailings auger 166 disposed in the tailings trough 164 carries the grain tailings to a side of the grain harvesting machine 102 and into a grain tailings elevator 168. The grain tailings elevator 168 communicates with the tailings auger 166 at an inlet opening of the grain tailings elevator 168 where grain tailings are received for transport for further processing. At a top end of the tailings elevator 168, an outlet opening (or other offload location) 170 is provided (e.g., for return to the thresher).

In a passive tailings implementation, the grain tailings elevator 168 carries the grain tailings upward and deposits them on a forward end of the rotor 138 to be re-threshed and separated. Alternatively, in an active tailings implementation, the grain tailings elevator 168 may deliver the grain tailings upward to an additional threshing unit (not shown) that is separate from the separator 136 and where the grain tailings are further threshed before being delivered to the main crop flow at the front of the cleaning subsystem 144. A discharge beater 172 is provided for discharging material from the rotor 138. The now-separated MOG is delivered to a residue subsystem 174 that can include a chopper 176 and a spreader 178 to be chopped by the chopper 176 and spread on the field by the spreader 178.

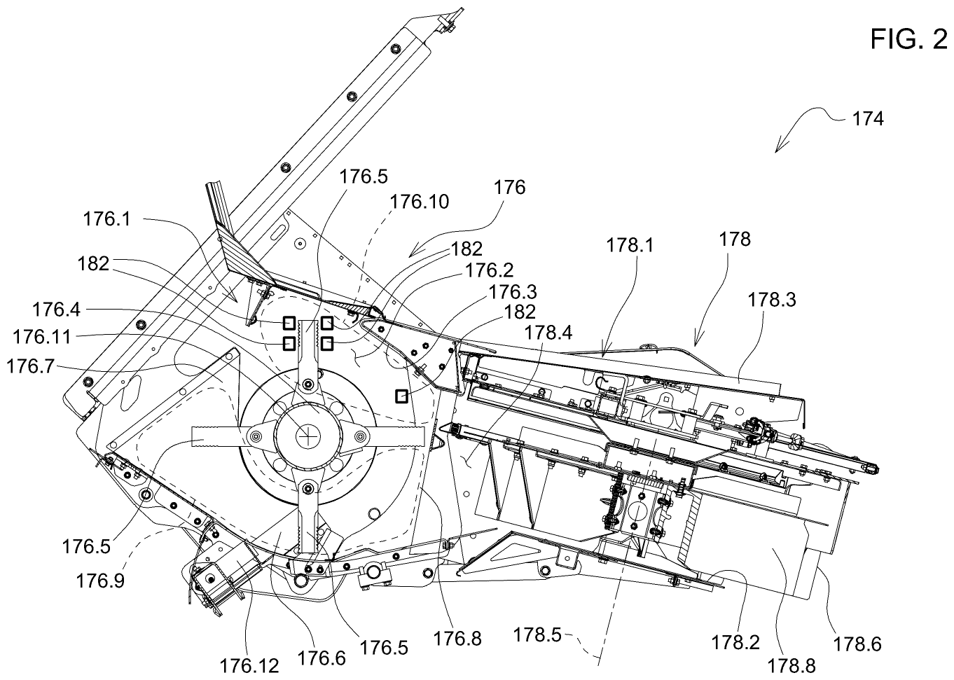

The details of the residue subsystem 174 are further shown in FIG. 2. The chopper 176 may include a chopper housing 176.1 including first and second side walls 176.2 and a third wall or back wall 176.3 disposed aft of the first and second side walls 176.2. A rotatable chopper rotor 176.4 may extend between the side walls 176.2 ahead of the third wall 176.3. The chopper rotor carries a plurality of chopper knives 176.5. A stationary knife assembly 176.6 is adjustably held in a fixed position on the chopper housing 176.1 and is configured to interact with the chopper knives 176.5 to chop the MOG into smaller pieces before the MOG is distributed onto the ground surface by the spreader 178. It will be appreciated that although the stationary knife assembly 176.6 is held in a fixed position relative to the chopper housing 176.1 during operation of the chopper 176, that position may be adjusted prior to operation in order to adjust the clearances between the stationary knife assembly 176.6 and the rotating chopper knives 176.5. A position actuator 176.12 may be provided for the stationary knife assembly 176.6 so as to adjust a relative position between the chopper knives 176.5 and the stationary knife assembly 176.6.

The chopper 176 further includes a chopper inlet 176.7 configured to receive the MOG and a chopper outlet 176.8 configured to distribute the MOG. A MOG flow area 176.9 is defined between the inlet 176.7 and the outlet 176.8 is the area where MOG is directed to flow during normal operation of the chopper 176. The primary location of the MOG flow area 176.9 has been outlined with a dashed border in FIG. 2.

Other areas within the chopper housing but outside of the MOG flow area 176.9 are designated as a MOG non-flow area 176.10 where MOG is not directed to flow during normal operation of the chopper 176. The primary location of the MOG non-flow area 176.10 has been outlined with a dashed border in FIG. 2, but it will be understood that the MOG non-flow area 176.10 can be any area within the chopper housing 176.1 and outside of the MOG flow area 176.9.

In the embodiment illustrated in FIG. 2 the MOG flow area 176.9 extends from the chopper inlet 176.7 through the portion of housing 176.1 below the chopper rotor 176.4, to the chopper outlet 176.8. In this embodiment the MOG flow area 176.9 can be generally described as lying at an elevation below a rotational axis 176.11 of rotor 176.4. In the illustrated embodiment the chopper rotor 176.4 rotates counter-clockwise as seen in FIG. 2, such that the chopper knives 176.5 sweep upward past the chopper outlet 176.8. Thus, in this embodiment the MOG non-flow area 176.10 can be further described as being located at least in part above the chopper outlet 176.8 and above the chopper rotor 176.4.

As further shown in FIG. 2, the spreader 178 is connected to the chopper 176 and receives the MOG from the chopper outlet 176.8. Spreader 178 includes a spreader housing 178.1 including a housing floor 178.2, a housing ceiling 178.3 and two side walls 178.4 joining the floor 178.2 and ceiling 178.3. A rotating spreader rotor 178.8 rotates about generally vertical axis 178.5, pulling in ambient air from below and blowing the MOG out the back outlet 178.6 of spreader 178. The spreader 178 is configured to spread the MOG across a width 188 of the machine 102 as the machine 102 harvests a crop.

The present disclosure is particularly directed to a residue monitoring system 180 including at least one sensor 182 configured to detect a presence of MOG in the MOG non-flow area 176.10. The at least one sensor 182 may include a plurality of sensors. Preferably the at least one sensor 182 is mounted on one or both of the side walls 176.2 of the chopper housing 176.1 and/or on the third wall 176.3 of the chopper housing 176.1. The MOG in the MOG non-flow area 176.10 may either be moving with the air flow through that area or it may be stationary MOG that is accumulated in certain parts of the MOG non-flow area 176.10.

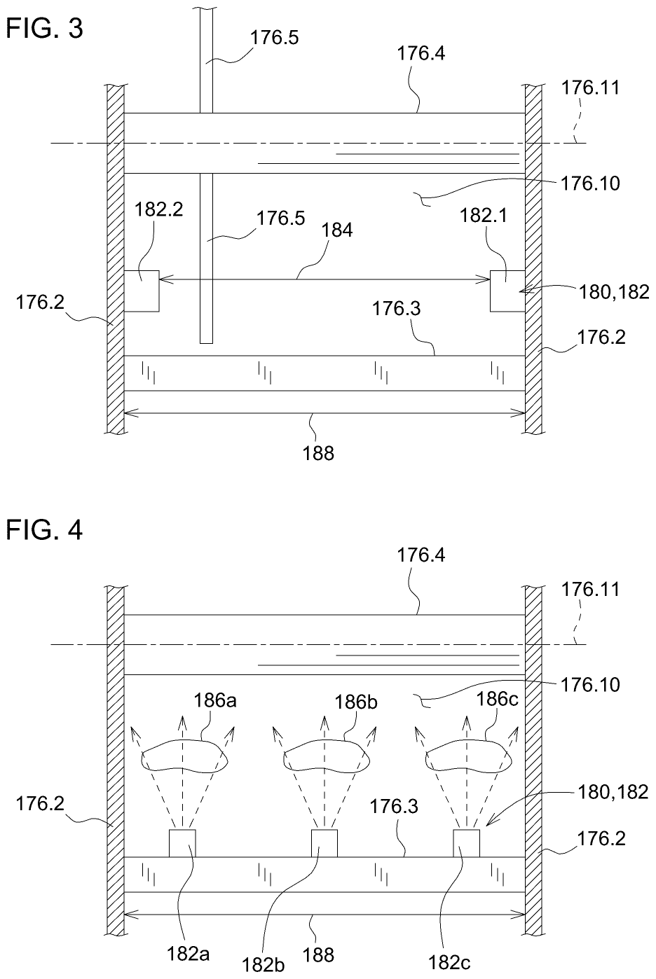

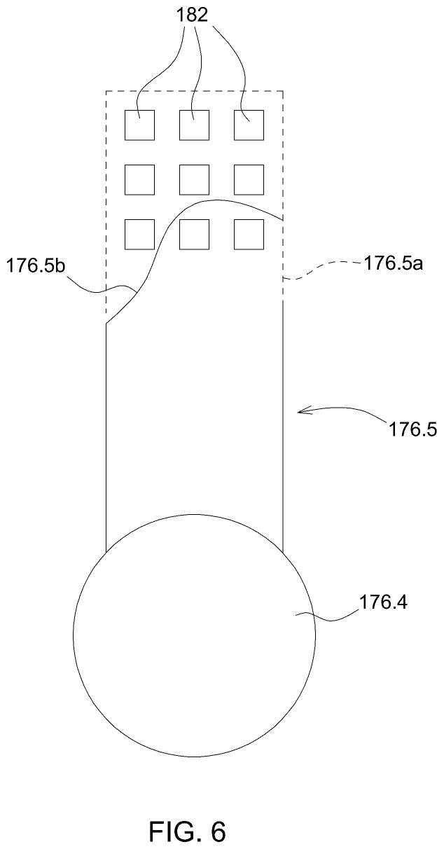

As schematically shown in FIG. 3, if the at least one sensor 182 is mounted on one or both of the side walls 176.2 the sensor may be oriented so as to detect the presence of MOG along a detection path 184 in a direction generally parallel to the rotational axis 176.11 of the chopper rotor 176.4. If the at least one sensor 182 is of such a design as to include separated sensor transmitter 182.1 and receiver 182.2, then the transmitter 182.1 may be mounted on one of the side walls 176.2 and the receiver 182.2 may be mounted on the other of the side walls 176. As further explained below regarding FIG. 6, there may be an array of such sensors 182 mounted on the side walls 176.2 so as to detect the presence of MOG throughout the MOG non-flow area 176.10.

As is schematically shown in FIG. 4, if the at least one sensor 182 is mounted on the third wall 176.3, the at least one sensor 182 may be oriented to detect a presence of MOG along a detection path 186 in a direction generally transverse to the rotational axis 176.11 of the chopper rotor 176.4. In FIG. 4, the at least one sensor 182 is shown to include three sensors 182a, 182b, and 182c, which have detection paths 186a, 186b and 186c, respectively. It will be understood that the detection paths such as 186a may be cone shaped as indicated in dashed lines so that each of the sensors 182a, 182b, 182c can detect the presence of MOG along a portion of the length of the chopper rotor 176.4 within the MOG no-flow area 176.10.

The sensors 182 may utilize any conventional sensor technology. For example, the sensor 182 of FIG. 3 using a sensor transmitter 182.1 and a sensor receiver 182.2 may be a laser based sensor. The sensors 182 may also be capacitive sensors configured to detect the presence of a mass of material within the zone monitored by the sensor. The sensors 182 may also be optical sensors, including but not limited to camera based sensors. The sensors 182 may also be visible or invisible light sensors. The sensors may also be infrared sensors. The sensors may also be radar sensors.

### The Control System

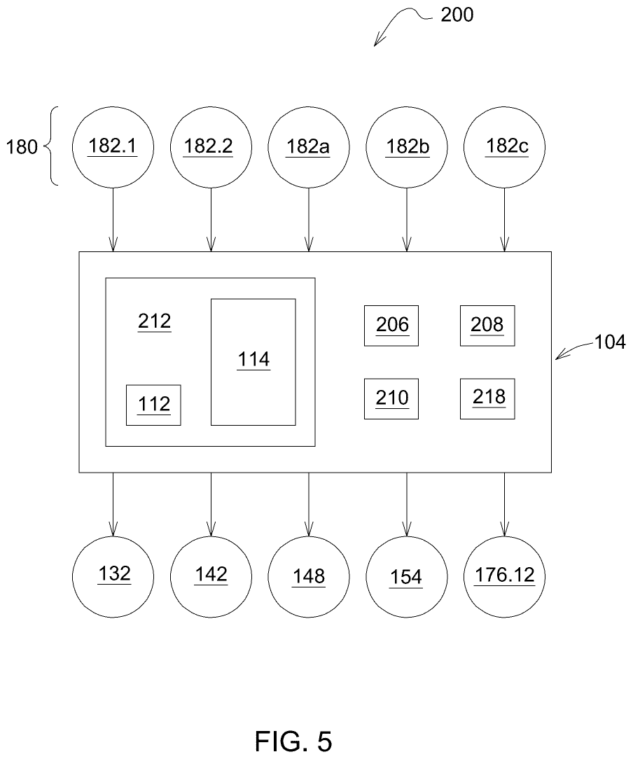

As schematically illustrated in FIG. 5, the machine 102 includes a control system 200 including the controller 104. The controller 104 may be part of the machine control system of the grain harvesting machine 102, or it may be a separate control module. The controller 104 may for example be mounted in a control panel 212 located at the operator's station 110. Controller 104 is configured to receive input signals from the various sensors 182. The signals transmitted from the various sensors to the controller 104 are schematically indicated in FIG. 5 by lines connecting the sensors to the controller with an arrowhead indicating the flow of the signal from the sensor to the controller 104.

For example, signals from the sensors 182 will be received by controller 104, which may be configured to determine whether MOG is present in the MOG non-flow area 176.11 above a permitted threshold level. Controller 104 may also receive signals from other machine sensors as well as from the operator input devices 112 at the operator station 110.

Similarly, the controller 104 will generate control signals for controlling the operation of various actuators of the grain harvesting machine 102. Those actuators may for example be associated with various subsystems of the grain harvesting machine which affect the size and nature of the MOG processed by the residue subsystem 174.

Controller 104 includes or may be associated with a processor 206, a computer readable medium 208, a data base 210 and the input/output module or control panel 212 having the previously mentioned display 114. The previously mentioned input/output device 112, such as a keyboard, joystick or other user interface, is provided so that the human operator may input instructions to the controller. The input/output device 112 may be distributed across multiple locations and may include remote operator input devices. It is understood that the controller 104 described herein may be a single controller having all of the described functionality, or it may include multiple controllers wherein the described functionality is distributed among the multiple controllers.

Various operations, steps or algorithms as described in connection with the controller 104 can be embodied directly in hardware, in a computer program product 218 such as a software module executed by the processor 206, or in a combination of the two. The computer program product 218 can reside in RAM memory, flash memory, ROM memory, EPROM memory, EEPROM memory, registers, hard disk, a removable disk, or any other form of computer-readable medium 208 known in the art. An exemplary computer-readable medium 208 can be coupled to the processor 206 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 208 and/or database 210 may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

### Methods Of Operation

The controller 104 may be configured to detect a presence of MOG within the MOG non-flow area 176.11 using at least one sensor 182. The controller 104 may receive a threshold setting for the signals from the at least one sensor 182 corresponding to a permissible level of MOG within the MOG non-flow area 176.11. The threshold setting may be input or adjusted by an operator via the operator input devices 112. The threshold setting may also be provided automatically via software programming 218 stored in memory 208.

The controller 104 may be further configured to initiate a responsive action if the presence of MOG in the MOG non-flow area 176.11 is detected to be above the threshold level.

In one embodiment, the responsive action may include providing a visual, audible or tactile warning to a human operator of the grain harvesting machine 102 via the control panel 212. It is further noted that the grain harvesting machine 102 may be an autonomous machine and the warning may be provided to a remote operator of such an autonomous machine.

In another embodiment, the responsive action may include automatically adjusting an operating parameter of a component of the grain harvesting machine 102 to reduce a level of MOG in the MOG non-flow area 176.10. Adjusting an operating parameter may include reducing a feed rate of MOG into the residue subsystem 174. The feed rate of MOG into the residue subsystem 174 may be reduced by either slowing the advance speed of the grain harvesting machine 102 or increasing the cutting elevation 126 of the header 118 using actuator 132 so that less stalk material is processed with the grain of the cut crop.

Other subsystem actuators the adjustment of which may affect the size and nature of the MOG which reaches the residue subsystem 174 may include for example, the concave actuators 142, the fan actuator 148, and the actuation arrangement 154 associated with the sieve 150 and chaffer 152, just to name a few.

The controller 104 may further be configured to control the position actuator 176.12 for the stationary knife assembly 176.6 so as to adjust a cutting clearance between the chopper knives 176.5 and the stationary knife assembly 176.6.

### Detection of Operational Conditions of Rotating Chopper Knives

As is apparent in FIG. 2, the rotating chopper knives 176.5 pass through the MOG no-flow area 176.10 as the chopper rotor 176.4 rotates. This presents the opportunity to use the same sensors 182 to detect an operational condition of the chopper knives 176.5.

Preferably the operational condition of the chopper knives 176.5 may be monitored at a time when the harvesting machine 102 is not harvesting crop and there is no MOG flowing through the residue subsystem 174. Various signal inputs to the controller 104 may indicate whether or not the harvesting machine 102 is performing a harvesting operation, such as detection of an advance speed of the harvesting machine 102 below a threshold speed, detection of a rotational speed of chopper rotor 176.4 below a threshold rotational speed, detection via GPS sensors 190 of the presence of the harvesting machine 102 in a geographic area which is not being harvested, or detection of mass flow through a portion of the harvester such as clean grain flow or separator material flow or cleaning shoe material flow.

Various operational conditions of the chopper knives 176.5 may be monitored using suitable arrangements of the sensors 182.

One detectible operational condition of the chopper knives 176.5 is a wear state of the knives. For example, using an array of sensors 182 mounted on the side walls 176.2 as schematically shown in FIG. 6, the physical wearing away of each knife blade may be detected. As is shown schematically in FIG. 6, an array of sensors 182 may project along detection paths such as path 184 of FIG. 3. A rectangular cross-sectional outline 176.5a represents the profile of one of the knives 176.5 in an unworn state. A curved upper profile 176.5b schematically represents the radially outer end of a worn knife 176.5. The array of sensors 182 is shown to include an upper row, a middle row and a lower row, and in the illustrated example only two of the sensors 182 of the lower row would detect the knife 176.5 thus indicating that the upper portions of the knife are worn away.

Such an array of sensors 182 may also detect knife position including knife angle, knife tilt, knife width, and knife height. The controller 104 may compare the actual knife position to an expected knife position which expected knife position may be input to the controller 104.

Additional sensors may be provided to monitor other operational conditions of the chopper knives 176.5. For example, vibration sensors may be provided to detect imbalance of the rotor 176.4 due to missing or broken knives 176.5.

The controller 104 may be configured such that during harvesting operations the sensors 182 are used to detect back feeding of MOG into the MOG non-flow area 176.10, and such that when the harvesting machine 102 is not performing harvesting operations the sensors 182 are used to periodically monitor one or more of the operational conditions of the chopper knives 176.5.

Upon detection of an unacceptable operational condition of one or more of the chopper knives 176.5 a corresponding warning may be communicated to the operator of the harvesting machine.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A grain harvesting machine for harvesting a crop material and separating the crop material into grain and material other than grain (MOG), comprising:
a grain thresher configured to separate grain from MOG;
a cleaning subsystem for further separating MOG from the separated grain;
a residue subsystem for chopping the MOG and distributing the MOG onto a ground surface behind the grain harvesting machine, the residue subsystem including a chopper including a chopper housing, a rotatable chopper rotor carrying a plurality of chopper knives, and a stationary knife assembly fixed in position relative to the chopper housing and configured to interact with the chopper knives to chop the MOG into pieces before the MOG is distributed onto the ground surface, the chopper further including a chopper inlet configured to receive the MOG, a chopper outlet configured to distribute the MOG, a MOG flow area between the inlet and the outlet wherein MOG is directed to flow during normal operation, and a MOG non-flow area where MOG is not directed to flow during normal operation; and
a residue monitoring system including at least one sensor configured to detect a presence of MOG in the MOG non-flow area.

2. The grain harvesting machine of claim 1, wherein:
the chopper housing includes a first side wall, a second side wall, and a third side wall extending between the first side wall and the second side wall and disposed aft of the first side wall and the second side wall, the chopper rotor extending between the first side wall and the second side wall ahead of the third side wall; and
the at least one sensor is mounted on one or more of the first side wall, the second side wall or the third side wall.

3. The grain harvesting machine of claim 2, wherein:
the at least one sensor is mounted on the first side wall, the second side wall, or both the first side wall and the second side wall and is configured to detect a presence of MOG along a detection path in a direction generally parallel to a rotational axis of the chopper rotor.

4. The grain harvesting machine of claim 2, wherein:
the at least one sensor is mounted on the third side wall and is configured to detect a presence of MOG along a detection path in a direction generally transverse to a rotational axis of the chopper rotor.

5. The grain harvesting machine of claim 1, wherein:
the at least one sensor includes a laser sensor.

5. The grain harvesting machine of claim 1, wherein:
the at least one sensor includes a capacitive sensor.

7. The grain harvesting machine of claim 1, wherein:
the at least one sensor includes a camera.

8. The grain harvesting machine of claim 1, wherein:
the MOG flow area extends from the chopper inlet below the chopper rotor to the chopper outlet;
the chopper rotor rotates in a direction such that the chopper knives sweep upward past the chopper outlet; and
the MOG non-flow area is located at least in part above the chopper outlet and above the chopper rotor.

9. The grain harvesting machine of claim 1, further comprising:
a controller operatively associated with the at least one sensor and configured to detect whether MOG is present in the MOG non-flow area above a threshold level.

10. The grain harvesting machine of claim 9, wherein:
the controller is further configured to initiate a responsive action if a presence of MOG in the MOG non-flow area above the threshold level is detected.

11. The grain harvesting machine of claim 10, wherein:
the controller is further configured such that the responsive action includes providing a visual, audible or tactile warning to a human operator of the grain harvesting machine.

12. The grain harvesting machine of claim 10, wherein:
the responsive action includes an automatic adjustment to an operating parameter of a component of the grain harvesting machine to reduce a level of the MOG in the MOG non-flow area.

13. The grain harvesting machine of claim 12, wherein:
the automatic adjustment to the operating parameter includes an automatic reduction to a feed rate of MOG into the residue subsystem.

14. The grain harvesting machine of claim 13, wherein:
the automatic reduction to the feed rate of MOG into the residue subsystem includes an automatic reduction to an advance speed of the grain harvesting machine, an automatic increase in a header cutting elevation of the grain harvesting machine, or both.

15. The grain harvesting machine of claim 12, wherein:
the automatic adjustment of the operating parameter includes an automatic adjustment to a position of the stationary knife assembly relative to the chopper knives.

16. The grain harvesting machine of claim 9, wherein:
the controller is further configured to detect an operational condition of the chopper knives based at least in part on a signal from the same at least one sensor used to detect the presence of MOG in the MOG non-flow area.

17. The grain harvesting machine of claim 1, further comprising:
a spreader connected to the chopper outlet and configured to spread the MOG across a width of the grain harvesting machine.

18. A method of operating a grain harvesting machine for harvesting a crop material and separating the crop material into grain and material other than grain (MOG), the grain harvesting machine including a residue subsystem for chopping the MOG and distributing the MOG onto a ground surface behind the grain harvesting machine, the residue subsystem including a chopper including a chopper housing, a rotatable chopper rotor carrying a plurality of chopper knives, and a stationary knife assembly fixed in position relative to the chopper housing and configured to interact with the chopper knives to chop the MOG into smaller pieces before the MOG is distributed onto the ground surface, the chopper having a chopper inlet for receiving the MOG, a chopper outlet for distributing the MOG, a MOG flow area between the inlet and the outlet along which MOG is directed to flow during normal operation, and a MOG non-flow area in which MOG is not directed to flow during normal operation, the method comprising:
detecting with at least one sensor a presence of MOG in the MOG non-flow area above a threshold level; and
initiating a responsive action with a controller if the presence of MOG in the MOG non-flow area above the threshold level is detected.

19. The method of claim 18, wherein:
initiating the responsive action includes providing a visual, audible or tactile warning to a human operator of the grain harvesting machine.

20. The method of claim 18, wherein:
initiating the responsive action includes automatically adjusting with the controller an operating parameter of a component of the grain harvesting machine to reduce the presence of the MOG in the MOG non-flow area.
